(19) United States
(12) Patent Application Publication
(10) Pub. No.: US 2007/0222784 A1
(43) Pub. Date: Sep. 27, 2007

(54) Method for Graphically Generating Rounded-End Lines

(76) Inventors: David Arneau, Pessac (FR); Eric Filliatre, Merignac (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/587,059

(22) PCT Filed: Mar. 9, 2005
(86) PCT No.: PCT/EP05/51043

§ 371 Date: Oct. 20, 2006

(30) Foreign Application Priority Data
Apr. 20, 2004 (FR) 04/04147

(51) Int. Cl. G06T 11/20

(52) U.S. Cl. 345/441

(57) ABSTRACT

The field of the invention is that of graphical libraries providing graphical functions used for drawing symbologic images. The object of the invention is to replace the rectangular elementary lines with lines having rounded ends so as to eliminate the problems of artifacts which appear when a thick line is represented by a simple rectangle. The invention describes the various steps of the graphical method of generating lines according to the invention in the case involving elementary lines or open or closed broken lines.

### CROSS-REFERENCE TO RELATED APPLICATIONS

The present Application is based on International Application No. PCT/EP2005/051043, filed on Mar. 9, 2005, which in turn corresponds to France application Ser. No. 04/04147 filed on Apr. 20, 2004, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of graphical libraries providing graphical functions used for drawing symbologic images. One of the fields of favored application is the generation of symbologic images for the piloting of aircraft. These images are in particular used for navigation, piloting and management of critical systems, such as engine checks.

2. Description of the Prior Art

The graphical images are generated on matrix screens, such as, for example, liquid crystal displays. The generation of the graphical image is done in the following manner: a buffer-memory called a “frame-buffer” is filled with the various symbologies necessary for the image, these symbologies generated by a computer of symbols being assigned an order of priority; when all the symbologies have been created in the buffer-memory, its content is then dispatched to the display. These graphical images are generated in real time.

The graphical symbols are represented by a set of broken lines comprising a succession of adjacent elementary straight lines. When the line is thick, it is represented by a rectangular line body, the width of the rectangle being equal to the thickness of the line and the length of the rectangle to the length of the line. When a thick broken line is created on the basis of these elementary rectangles, discontinuities are obtained at the junction of two adjacent rectangles as indicated in FIG. 1 which represents the letter C. These discontinuities are visually rather unesthetic and can give rise to confusions between two neighboring symbols.

### SUMMARY OF THE INVENTION

The object of the invention is to replace the rectangular elementary lines with lines having rounded ends so as to eliminate this problem.

More precisely, the invention is aimed at a method of graphical generation of a thick straight line, said line comprising a rectangular line body, the width of the rectangle being equal to the thickness of the line and the length of the rectangle to the length of the line, characterized in that the line body also comprises two half-disks centered on the sides of the rectangle of dimension equal to the thickness of the line, said half-disks having a diameter equal to this same thickness.

Its subject is also a method of graphical generation of a broken line comprising a succession of adjacent elementary straight lines of like thickness, each elementary line being represented by a rectangular line body, the width of the rectangle being equal to the common thickness and the length of the rectangle to the length of the elementary line, characterized in that each intersection of two adjacent successive lines making a nonzero angle between themselves is constructed in the following manner:
the point of intersection of the two lines is situated at the center of the intersected sides of said lines;
the intersection comprises an angular sector centered on said point of intersection, of radius equal to half the common thickness and of angle equal to the angle that said lines make between themselves.

Advantageously, when the broken line is open, the line bodies situated at the free ends each comprise a half-disk having a diameter equal to the thickness of the broken line.

Advantageously, in a step of the method, each elementary line is decomposed into a central rectangle corresponding to the line body, the width of said rectangle being equal to the thickness of the line and the length of the rectangle to the length of the line and two peripheral rectangles situated on the sides of the central rectangle, the length of said rectangles being equal to the thickness of the line and their width being equal to half said length.

Also, the matrix space of the display is decomposed into angular sectors oriented with respect to a favored oriented axis of the matrix, the decomposition comprises 8 sectors, 4 first sectors corresponding to the favored axis of the matrix and to the axes oriented respectively at 90 degrees, 180 degrees and 270 degrees to this axis, 4 second sectors corresponding to the angular sectors situated between said first sectors.

Advantageously, the method comprises a step of determination of the bottom left, bottom right, top right and top left limit points of each rectangle making up each line as a function of the orientation of the line in the various angular sectors, the boundaries defining the pixels belonging to the rectangles making up the line obey defining rules dependent on the orientation of the line in the various angular sectors.

Finally, the color of each pixel of the line depends:
for the body of the line, on the color of origin of the line, on the color of the background on which the line is drawn and on the distance of the pixel from the central axis of the body of the line;
for the half-disks of a straight line, on the color of origin of the line, on the color of the background on which the line is drawn and on the distance of the pixel from the center of the half-disk;
for the angular sectors situated at the intersection of two elementary lines, on the color of origin of the lines, on the color of the background on which the lines are drawn and on the distance of the pixel from the point of intersection of the two lines.

### BRIEF DESCRIPTION OF THE DRAWINGS

The invention will be better understood and other advantages will appear on reading the nonlimiting description which follows and by virtue of the appended figures among which:

FIG. 1 represents the generation of a symbol according to the prior art;

FIG. 2 represents the generation of an elementary straight line according to the invention,

FIG. 3 represents the generation of a broken line consisting of two elementary straight lines according to the invention;

FIG. 4 represents the same symbol as that of FIG. 2 but obtained by the method according to the invention;

FIG. 5 represents the decomposition of the line according to the invention into elementary rectangles;

FIG. 6 represents the determination of the rows of pixels making up the elementary rectangles;

FIG. 7 represents the pixel filling procedure;

FIG. 8 represents a line drawn according to the invention with the procedure termed “antialiasing” making it possible to attenuate the effects due to pixellation;

FIG. 9 represents the determination of the angular sector at the intersection of two elementary lines.

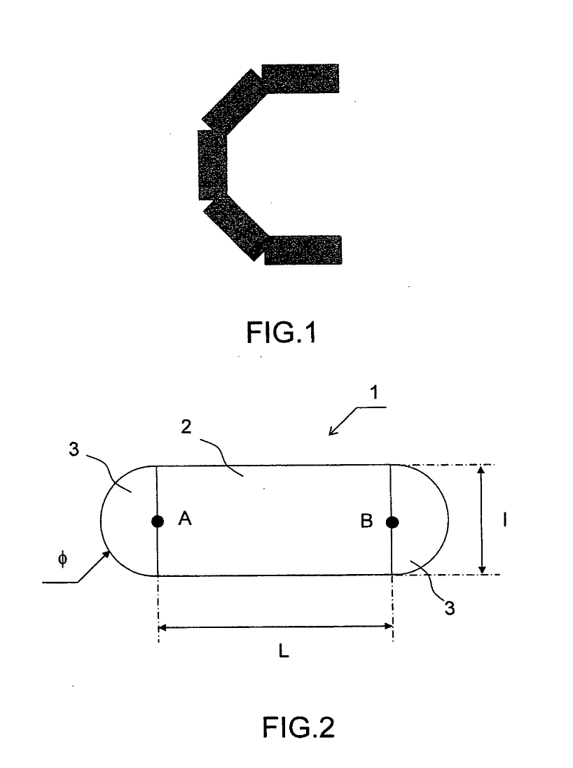

### MORE DETAILED DESCRIPTION

FIG. 2 represents a line 1 according to the invention. It comprises:
a rectangular line body 2, the width l of the rectangle being equal to the thickness of the line and the length L of the rectangle to the length of the line,
Two half-disks 3 centered on the sides of the rectangle of dimension equal to the thickness of the line, said half-disks having a diameter φ equal to this same thickness, the centers A and B of each circle delimiting the half-disks being merged with the centers of the sides of the rectangles corresponding.

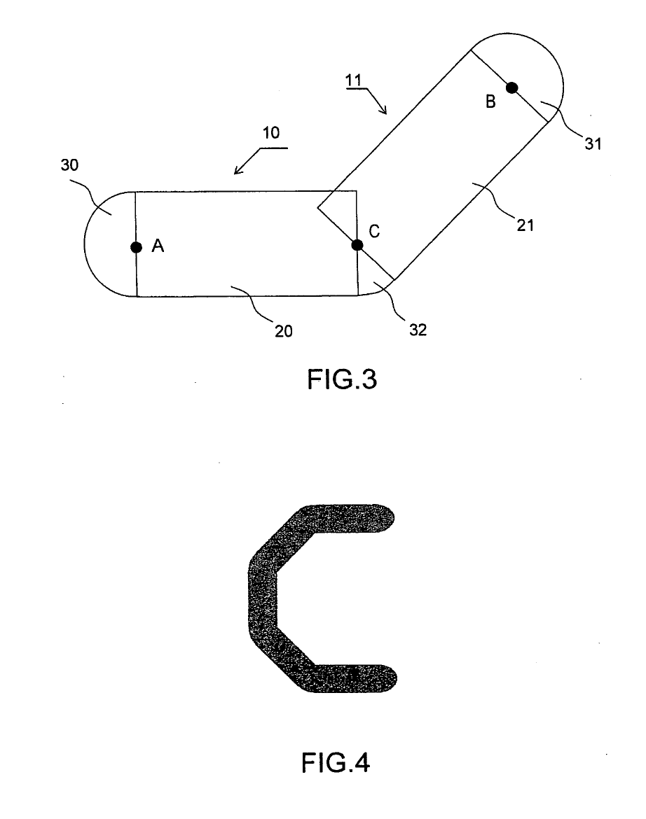

FIG. 3 represents the generation of a broken line consisting of two elementary straight lines 10 and 11 according to the invention. It comprises:
a first line body 20 corresponding to the line 10;
a second line body 21 corresponding to the line 11, the point of intersection C common to the sides of the first line body 20 and of the second line body 21 is situated at the center of the intersected sides of said bodies 20 and 21;
a first half-disk 30 centered on the free end of the first line body 20;
a second half-disk 31 centered on the free end of the second line body 21;
an angular sector 32 centered on the point of intersection C, of radius equal to half the common thickness and of angle equal to the angle that said lines make between themselves.

In a general manner, for any broken line comprising a succession of adjacent elementary straight lines of like thickness, each elementary line is represented by a rectangular line body, the width of the rectangle being equal to the common thickness and the length of the rectangle to the length of the elementary line, each intersection of two adjacent successive lines making a nonzero angle between themselves is constructed in the following manner:
the point of intersection of the two lines is situated at the center of the intersected sides of said lines;
the intersection comprises an angular sector centered on said point of intersection, of radius equal to half the common thickness and of angle equal to the angle that said lines make between themselves.

When the broken line is open, the line bodies situated at the free ends each comprise a half-disk having a diameter equal to the thickness of the broken line.

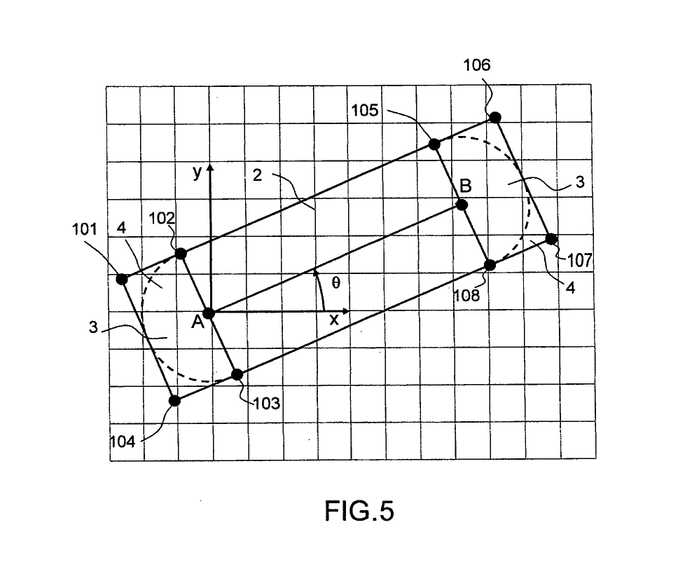

FIG. 4 is an example of an open broken line according to the invention comprising 5 elementary straight lines. It represents the same symbol C as that of FIG. 2. In this case, it is clear that the symbol is much more readable, the discontinuities have disappeared.

Any graphical image is composed of elementary pixels. The determination of the pixels of the line and their filling with the appropriate color must comply with three essential criteria:
the generation of a line according to the invention must contain only the pixels of the body of the line and of its rounded ends.
the buffer-memory is a matrix memory composed of N rows denoted R composed of pixels P, each pixel comprising calorimetric information on the symbol to be drawn. For reasons of ease of filling in the buffer-memory, also called a “frame-buffer”, the various pixels making up the line are successively filled with the calorimetric information row by row.
a procedure known by the term “antialiasing” making it possible to attenuate the visual effect due to the pixellation of the display is applied to the pixels making up the line. This procedure consists in mixing for the pixels situated at the boundaries of the elements of the line the color of the line with the color of the background by applying a mixture law dependent on the distance of the pixel from the center of the line.

By way of example, a method making it possible to correctly determine the pixels of the line according to the invention comprises the following steps:
Step 1: decomposition of the line into three elementary rectangles;
Step 2: decomposition of the space of the display into angular sectors and determination of the orientation of the line in said sectors;
Step 3: putting in place of protocols for determining the pixels delimiting the elementary rectangles as a function of the angular sector occupied;
Step 4: determination of the extreme limit points of each rectangle as a function of the orientation of the line in said sectors,
Step 5: determination of the left and right increments making it possible to pass from one row to the following row,
Step 6: application of the “antialiasing” procedure to the pixels retained by the preceding steps.

The buffer-memory in which the colors of each pixel of the line to be drawn are stored is a matrix memory composed of R rows composed of N pixels P.

Step 1 consists in substituting for each half-disk a rectangle one of whose sides is merged with the base of the half-disk and whose width is equal to the radius of the half-disk. The line thus modeled comprises three rectangles as indicated in FIG. 5:
A first rectangle 2 which constitutes the body of the line. It is defined by a central axis AB and is delimited by the 4 points 102, 105, 108 and 103;
A second rectangle 4 which encompasses the first half-disk 3 depicted dashed. It is delimited by the points 101, 102, 103 and 104.
A third rectangle 4 which encompasses the second half-disk 3 depicted dashed. It is delimited by the points 105, 106, 107 and 108.

Each point is referenced in a frame of reference (x, y) taken from the matrix of pixels as indicated in FIG. 5. The x axis is chosen parallel to the rows of pixels. By thus substituting the half-disks which are complex shapes with simpler rectangular shapes, graphical management thereof is simplified accordingly.

Step 2 consists in tagging the orientation AB of the central axis defining the line. This orientation is obtained by means of the angle θ that the axis defining the straight line makes with the x axis of the frame of reference of the matrix as indicated in FIG. 5. We thus define 8 angular sectors described below, according to the value of this angle:
Sector 0: 0°<θ<90°
Sector 1: 90°<θ<180°
Sector 2: 180°<θ<270°
Sector 3: 270°<θ<360°
Sector 4: θ=90°
Sector 5: θ=270°
Sector 6: θ=0°
Sector 7: θ=180°

Step 3 consists in putting in place a protocol for determining the pixels making up the limits of the elementary rectangles as a function of the angular sector occupied. Specifically, the points defining the limits of the various rectangles of the line do not correspond, save for exceptions, to pixel sites. It is necessary therefore to use laws making it possible to determine the pixels fixing the limits of the elementary rectangles. These laws obey four essential criteria:
the surfaces occupied by the elementary rectangles should be filled as best as possible;
no zones should be left without pixels at the boundary between two rectangles;
there should not be different thicknesses along the line;
the pixels at the boundary between two rectangles should not be filled twice.

These laws for determining the limit pixels match the real coordinates expressed in pixels of the limit points of the rectangles with corresponding integer coordinates of pixels belonging to the matrix. There exist 2 major possible types of laws
First law: the coordinate of the pixel corresponds to the integer part of the real coordinate of the point;
Second law: the coordinate of the pixel corresponds to the integer part of the real coordinate of the point increased by 1.

For example, if the coordinate of a point is 3.72, then the corresponding coordinate will be either 3 or 4.

These laws are applied differently according to two criteria:
Type of rectangle considered: rectangle constituting the body of the line or the half-disks;
Type of angular sector to which said rectangles belong.

Step 4 consists in determining bottom left, bottom right, top right and top left limit points of each rectangle as a function of the orientation of the line in said sectors. For reasons of ease of filling in the buffer-memory, the various pixels making up the line are successively filled with the calorimetric information row by row beginning with the bottom left point of the rectangle up to the top right point. The determination of these points is essential. It does not present any difficulty given that the rectangles are oriented. Here again, these points will depend on the type of sector to which the rectangles belong.

Step 5 consists in determining the left d_{LEFT} and right d_{RIGHT} increments making it possible to determine the extreme points of a row R+1 of pixels with respect to the preceding row R so as to completely fill the pixels of each row. A and B being the limit points of the central axis of the body of the line, if x_{A}, y_{A} denote the coordinates of the point A and x_{B}, y_{B} the coordinates of the point B, we readily determine that the increments d_{LEFT} and d_{RIGHT} equal either

$$\pm ( \frac{{x}_{B} - {x}_{A}}{{y}_{B} - {y}_{A}} ) ,$$

or

$$\pm ( \frac{{y}_{B} - {y}_{A}}{{x}_{B} - {x}_{A}} )$$

according to the orientation of the rectangle. To determine the abscissae of the extreme points of a row with respect to the preceding row, it suffices to add the values δ_{LEFT} and δ_{RIGHT} to the abscissae of the extreme points of the preceding row, with:
δ_{LEFT}=Y.d_{LEFT}
δ_{RIGHT}=Y.d_{LEFT} Y being equal to the pitch of the pixels.

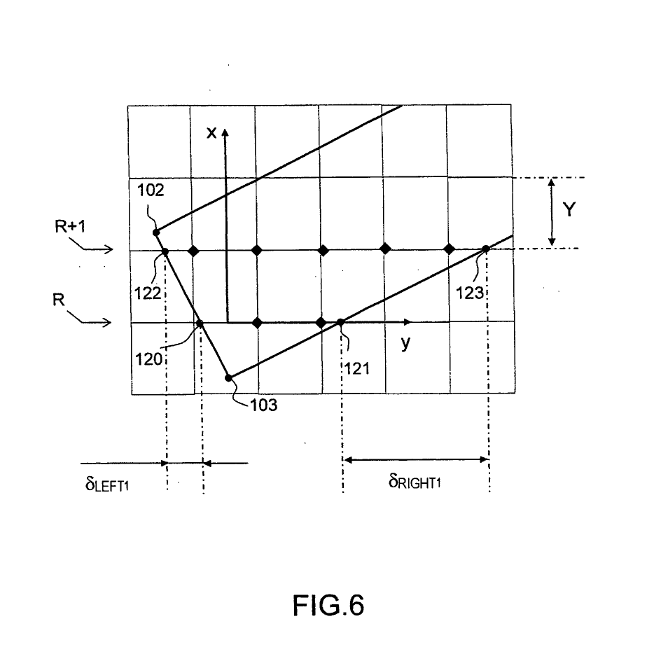

FIG. 6 illustrates this step. In this figure, the bottom left part of a rectangle 2 making up a line is represented on a matrix of pixels. The point 163 represents the bottom left point of the rectangle and the point 102 represents the top left point of the rectangle. Also represented are the values δ_{LEFT1} and δ_{RIGHT1} making it possible to determine the abscissae of the extreme points 122 and 123 of a row R+1 with respect to the extreme points 120 and 121 of the preceding row R when starting from the bottom left point 103. The pixels belonging to the rectangle are represented by black diamonds in this figure.

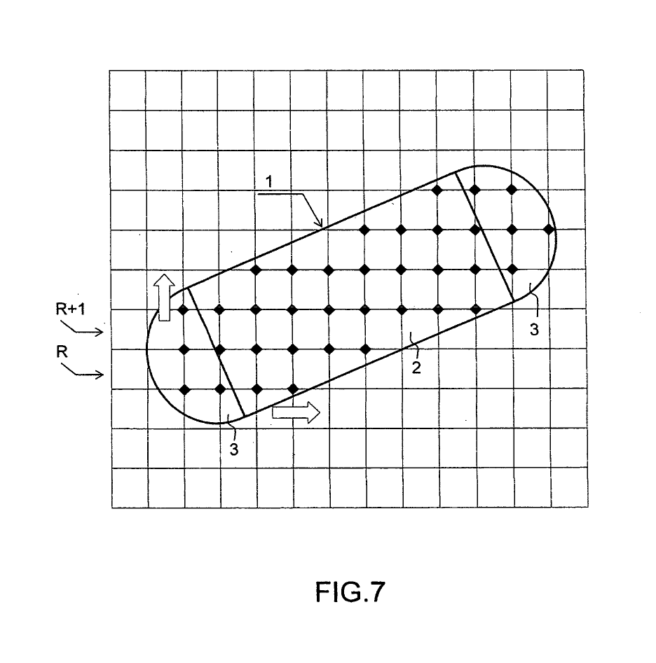

As may be seen in FIG. 6, when one passes from the bottom left point to the top left point, one changes side of the rectangle and consequently, the left d_{LEFT2} and right d_{RIGHT2} increments making it possible to determine the extreme points of a row of pixels with respect to the preceding row change. In the same way, when one passes from the bottom right point to the top right point, one changes side of the rectangle and consequently, the left d_{LEFT} and right d_{RIGHT} increments making it possible to determine the extreme points of a row of pixels with respect to the preceding row change too. To determine onward of which row the changes must occur, we calculate the number of rows separating two left extreme points or two right extreme points. FIG. 7 shows a line according to the invention with the sense of filling of the pixels of the line depicted by two white lines, the pixels of the line being represented by black diamonds.

At the end of step 5, all the pixels contained inside the various rectangles making up a line are determined.

Step 6 consists in determining the color of the various pixels making up the line. The “antialiasing” procedure is used on the pixels retained. It consists in mixing for the pixels situated at the boundaries of the line the initial color of the line with the color of the background by applying a mixture law, function of a transparency law dependent on a transparency coefficient and initial colors of the line and the background. For the lines according to the invention, the transparency law depends:
for the body of the line, on the distance of the pixel from the central axis of the body of the line;
for the half-disks of a straight line, on the distance of the pixel from the center of the half-disk, the transparency law being zero for the pixels not belonging to the half-disks.

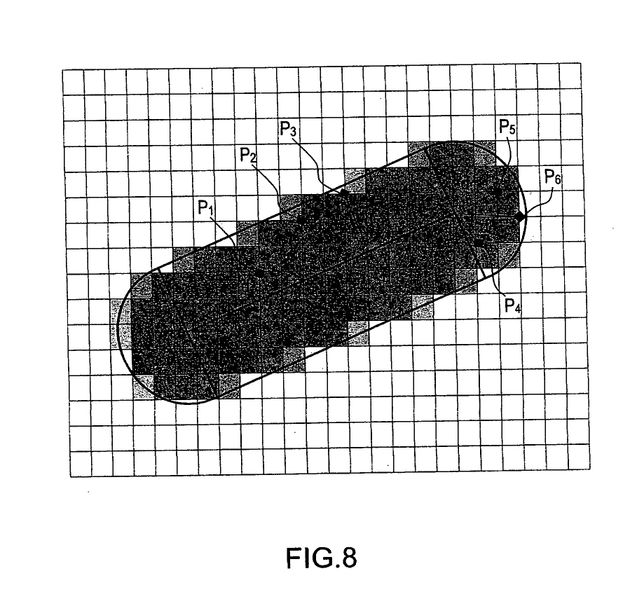

FIG. 8 shows the representation of a gray line on a white background according to the invention: It comprises two rounded ends. The pixels P1, P2 and P3 situated at the periphery of the line have lighter and lighter colors according to their separation d1, d2 and d3 from the axis of the line. The pixels P4, P5 and P6 situated at the periphery of the rounded end have lighter and lighter colors according to their separation d4, d5 and d6 from the center C of the half-circle constituting the disk.

When it is necessary to generate a broken line comprising several elementary lines, the preceding method comprises an additional step making it possible to manage the intersection of the consecutive lines. Each elementary line of the broken line comprises, as in the preceding case, a first rectangle which constitutes the body of the line, a second rectangle which encompasses the first half-disk, a third rectangle which encompasses the second half-disk. The point of intersection C of two lines is situated at the center of the sides of the rectangles constituting the body of the lines. To effect a correct intersection, it is necessary to determine the limit points of the intersection. These limit points are points of the rectangles of end of lines that are representative of the half-disks.

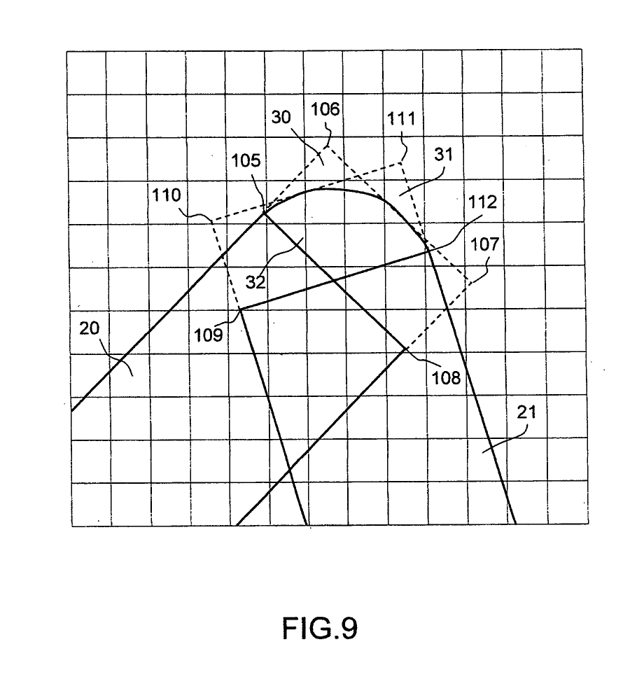

FIG. 9 represents the zone of intersection of two lines in the space of the pixels. Represented in FIG. 9 is the top part of the rectangle 20 and of the rectangle 30 representing the end of the first line 10 and also represented is the top part of the rectangle 21 and of the rectangle 31 representing the end of the second line 11. The rectangles 30 and 31 are represented dashed. The first rectangle 30 is delimited by the following points:
Point 105: bottom left limit
Point 106: top left limit
Point 107: top right limit
Point 108: bottom right limit

The second rectangle 31 is delimited by the following points:
Point 109: bottom left limit
Point 110: top left limit
Point 111: top right limit
Point 112: bottom right limit

The point of intersection of the two lines is also denoted by C. In the present case, only the pixels belonging to the zone 32 are filled, that is to say the zone limited by the points 105, 112 and C.

1. A method of graphical generation of a broken line comprising:
a succession of adjacent elementary straight lines of like thickness, each elementary line being represented by a rectangular line body having a width and length, the width of the rectangle being equal to the common thickness and the length of the rectangle to the length of the elementary line, each intersection of two adjacent successive lines making a nonzero angle between themselves and being constructed in the following manner:
a point of intersection C common to the two lines being situated at a center of the intersected sides of said lines; the intersection having an angular sector centered on said point of intersection, of radius equal to half the common thickness and of angle equal to the angle that said lines make between themselves,
wherein the matrix space of the display being decomposed into angular sectors oriented with respect to a favored oriented axis of the matrix, the decomposition having 8 sectors, 4 first sectors corresponding to the favored axis of the matrix and to the axes oriented respectively at 90 degrees, 180 degrees and 270 degrees to this axis, and 4 second sectors corresponding to the angular sectors situated between said first sectors.

2-8. (canceled)

9. The method of graphical generation as claimed in claim 1, wherein, when the broken line is open, the line bodies are situated at free ends each comprising a half-disk having a diameter equal to the thickness of the broken line.

10. The method of graphical generation as claimed in claim 1, wherein each elementary line is decomposed into a central rectangle corresponding to the line body, the width of said rectangle being equal to the thickness of the line and the length of the rectangle to the length of the line and two peripheral rectangles situated on the sides of the central rectangle, the length of said rectangles being equal to the thickness of the line and their width being equal to half said length.

11. The method of graphical generation as claimed in claim 1, wherein the matrix space of the display is decomposed into angular sectors oriented with respect to a favored oriented axis of the matrix.

12. The method of graphical generation as claimed in claim 11, wherein the decomposition comprises 8 sectors, 4 first sectors corresponding to the favored axis of the matrix and to the axes oriented respectively at 90 degrees, 180 degrees and 270 degrees to this axis, 4 second sectors corresponding to the angular sectors situated between said first sectors.

13. The method of graphical generation as claimed in claim 10, wherein the determination of the pixels delimiting the rectangles making up the line obey defining rules dependent on the orientation of the line in the various angular sectors.

14. The method of graphical generation as claimed in claim 10, comprising a step of determination of the bottom left, bottom right, top right and top left limit points of each rectangle making up each line as a function of the orientation of the line in the various angular sectors.

15. The method of graphical generation as claimed in claim 1, wherein the color of each pixel of the line depends:
for the body of the line, on the color of origin of the line, on the color of the background on which the line is drawn and on the distance of the pixel from the central axis of the body of the line;
for the half-disks of a straight line, on the color of origin of the line, on the color of the background on which the line is drawn and on the distance of the pixel from the center of the half-disk;
for the angular sectors situated at the intersection of two elementary lines, on the color of origin of the lines, on the color of the background on which the lines are drawn and on the distance of the pixel from the point of intersection of the two lines.
